(19) United States
(12) Patent Application Publication
(10) Pub. No.: US 2022/0178525 A1
(43) Pub. Date: Jun. 9, 2022

(54) METHOD FOR MINIMIZING AND ELIMINATING SHEETROCK SANDING USING AN ILLUMINATING DEVICE

(71) Applicant: James Scott Korman, Stony Brook, NY (US)

(72) Inventor: James Scott Korman, Stony Brook, NY (US)

(21) Appl. No.: 17/542,388

(22) Filed: Dec. 4, 2021

Related U.S. Application Data
(60) Provisional application No. 63/121,911, filed on Dec. 5, 2020.

(51) Int. Cl. F21V 21/096; F21S 9/02; E04F 21/165; F21Y 113/10; F21Y 115/10

(52) U.S. Cl. CPC F21V 21/096; F21S 9/02; F21Y 2115/10; F21Y 2113/10; E04F 21/165

(57) ABSTRACT

A method to minimize or eliminate sanding by illuminating an area by showing contrasting areas of light and dark distinguishing imperfections in the gypsum board and where to fill and taper a plurality of layers of joint compound to finish gypsum boards to a height of zero using a lighting device that includes LEDs, at least one magnet, and a power supply unit. The lighting device comprises a junction box having a top face and LED diodes secured therein. On one side of the lighting device is the power switch. A low voltage wire network runs through the junction box and power supply unit. The lighting device is magnetically securable to metal fasteners in the gypsum board. The power supply unit includes an internal battery and a power switch. The portable lighting device is connectible to the internal battery.

### CROSS REFERENCE TO RELATED APPLICATIONS

The present application claims the benefit of priority based of U.S. Provisional Patent Application No. 63/121,911, filed on Dec. 5, 2020. The disclosure of application 63/121,911 is incorporated herein by reference in its entirety.

### SPECIFICATION

### Technical Field

The present application is for a lamp for detecting and defining imperfections in gypsum board for home improvement industry and can be utilized by homeowners and professional contractors. The lighting tool has a magnetic head that allows as an attach mechanism to screws or metallic studs that holds gypsum board. The lighting tool uses a light-emitting diode (LED) as a light source to detect and define imperfections in gypsum board for new construction or remodeling applications.

### BACKGROUND

In building construction, different types of claddings are used as panels for forming interior and exterior wall and ceiling surfaces. For simplicity, as used herein, it will be understood that the term “wall” also encompasses ceilings. Typically, the claddings are in the form of boards (also referred to as panels) affixed to framing members such as in balloon framing arrangements known in the art. Examples of claddings include gypsum board faced with paper, fibrous mats (e.g., fiberglass), and the like. The use of gypsum board panels, typically referred to as “sheetrock” or “drywall”, became the preferred building material for interior walls and partitions in most types of buildings in the United States, primarily because of the relatively low cost of material and installation. These panels are essentially made of a hardened plaster-like gypsum material sandwiched between sheets of paper or cardboard material.

Sheetrock panels, are typically nailed or screwed to spaced wooden studs or joists to provide a flat wall or ceiling surface which spans these wooden supporting members, leaving the space between the studs or joists hollow behind the wall surface. These and other types of boards are typically cut to appropriate dimensions and then fastened to framing members, e.g., with screws, nails, or the like to form wall sections formed from multiple boards.

The surface of gypsum board wall sections is normally finished to provide aesthetically pleasing, uniform, and protected surfaces. The surface of a sheetrock wall is typically finished by filling irregularities and indentations, such as those in the areas where nails or screws have been driven through the face of the panel. The slight gaps between panels are similarly filled and taped over using paper tape which is sufficiently wide to bridge the gap between panels and which is held in place by the filler material. The filler is “drywall compound,” a mud-like material which is smoothed into place and allowed to dry and harden. However, even the dried filler material bas relatively little structural integrity and provides primarily the cosmetic benefit of a smooth wall or ceiling surface. The filler material by itself also has a tendency to shrink somewhat while drying and is therefore susceptible to cracking, particularly where it is used in large quantities or in thick layers.

For example, two side-by-side boards disposed in the same plane will form a joint seam between them on vertical walls and horizontal ceilings. To finish the seam, joint reinforcement tape is embedded in the seam, along with a layer of joint compound under the tape, and multiple coats of joint compound applied over the tape. The installed reinforcement is then concealed with multiple layers of joint compound applied over the corner trim. Fasteners used to affix the board to framing members must also be concealed with multiple layers of joint compound applied over them. After the various joint compound applications are dried, the resulting wall surfaces can be sanded and painted to form the desired uniform and aesthetically pleasing appearance.

The level of finishing as described above can vary. For example, with respect to gypsum wallboard, six (6) levels of gypsum board finish are understood in the art, ranging from zero (no treatment at all) to level five (the highest level of finish), as set forth in Gypsum Association document GA-214 and American Society for Testing and Materials (“ASTM”) C840.

The level of finish generally corresponds with the number of applications of joint compound to seams, trims, and fasteners. For example, level five is used the least and usually requires application of a skim coat of joint compound across the entire wall surface.

The primary drawback to using gypsum board material is that a certain degree of expertise is required to successfully apply joint compound to these surfaces in preparation to finish the gypsum board.

A simple, easy to use and inexpensive method for finishing sheetrock walls has eluded inventors, drywall professionals, handymen-homeowners, and building maintenance personnel, for as long as such materials have been in common use. Finishing gypsum board can be relatively difficult, especially in the most common situation where drywall sheets are butted together with no height difference to the rest of the wall board surface.

Conventional approaches for finishing wall assemblies as described above have not been fully satisfactory. The materials conventionally used to finish wall assemblies create significant inefficiencies in the process and also require an advanced level of skill to use effectively.

In addition, the need for applying multiple coats of joint compound requires that the user manipulate the joint compound significantly above the plane of the board. To allow the board to appear flat to the naked eye (even though it is not), significant skill and workmanship is required to achieve the proper visual appearance when the user is functioning above the plane of the board. The additional layers of joint compound must be feathered out wider and wider from the seam in a graduated manner to make the seam appear aesthetically flat. If the user is not significantly skilled, the visual appearance will not be satisfactory.

Presently, gypsum board walls for new construction and remodeling applications are installed with screws and the seams are taped and spackled. There are roughly (36) screw heads and 12 feet of seam tape per each 4 ft×8 ft gypsum board to be spackled. Typically, (3) coats of spackle followed by sanding are required in preparation to paint. Jobsite works lights are part of the process to see where the filling and sanding is required. With these types of work lights, the detail is mostly rendered in a two-dimensional (2-D) format with the fine details sometimes being overlooked. The installer is also frequently working in their own shadow due to the positional of the work lights. The spackle work is followed by multiple coats of paint. Often surface imperfections that are not corrected before paint are visible after the job has been completed when illuminated with electric or natural light. These imperfections can be in the form of dirt, debris, gouges, ridges, bumps, dings, dimples, and the edges of joint compound which have not been completely feathered out to zero.

There is a need for a way to pinpoint precisely where to apply spackle/joint compound and sand prior to paint. This would also reduce the amount of spackle/joint compound required and minimize the sanding process. Another time saving feature would be going illuminating the gypsum board to visualize the exact location needing preparation work.

It will be appreciated that this background description has been created by the inventors to aid the reader and is neither to be taken as a reference to prior art not as an indication that any of the indicated problems were themselves appreciated in the art. While the described principles can, in some regards and embodiments, alleviate the problems inherent in other systems, it will be appreciated that the scope of the protected innovation is defined by the attached claims and not by the ability of the claimed invention to solve any specific problem noted herein.

### BRIEF SUMMARY

The present invention overcomes the aforementioned problems by providing a method that precisely illuminates areas on the gypsum board with depressions, aberrations and anomalies.

The method of illuminating aforementioned issues include a lighting device. The lighting device comprises a magnet or other mechanically adhesive part that allow one to attach the lighting device to screw, nail head or any metallic fixture that is in the gypsum board. The light source is secured within a framework, housing, enclosure or junction box. The enclosure can be made of polycarbonate or any other composite material that is shock resistant, waterproof and with a smooth outer surface.

The diodes of the lighting source are positioned orthogonally at the outermost layer of the junction box. The diodes are securable to the framework of the junction box such that the diodes are directed away from the centerline of the device to cast light across the surface of the gypsum board.

The lighting device is removably securable from the gypsum board by means such as magnets connected to a metal fastener such as a screw or nail. When magnetically connected to the screw or any other magnetic fixture in the gypsum board the light emitted from lighting device will be dispersed across the surface of gypsum board.

The projected light pattern highlights the visibility of any flaws or imperfections in the body surface by magnifying an observer's perception of relative depth differences between the flaw and the unflawed body surface. The diodes can be a variety of colors and variations of white light emitting diode can used for to highlight imperfections and anomalies in sheetrock.

The method itself is directed to pinpointing precisely where to apply spackle or joint compound and sand prior to painting. This would reduce the amount of spackle/joint compound required and minimize the sanding process. Ultimately, saving time and resources by pinpointing the exact location needing preparation work.

The portable light device is powered by an internal rechargeable battery which permits the use of this lighting device at remote locations where a standard outlet may not be accessible. Further, such an arrangement permits use of the lighting device in situations where it would be impractical and potentially dangerous to use a lengthy extension cord to provide power to the light source. For example, use of the portable light panel with an internal and rechargeable battery pack is particularly well adapted for use in construction where the lighting device can be attached to a screw, for example, in gypsum board so specific areas can receive joint compound precisely and without excess in the method of this invention.

### BRIEF DESCRIPTION OF THE DRAWINGS

The drawings constitute a part of this specification and include exemplary embodiments of the invention, which may be embodied in various forms. It is to be understood that in some instances various aspects of the invention may be shown exaggerated or enlarged to facilitate an understanding of the invention.

FIG. 1 Is an enlarged perspective of the device of this invention.

FIG. 2 is a side cross-sectional view of the device of this invention.

FIG. 3 is an enlarged view of the screw head in gypsum board wall to show where to feather the spackle to minimize sanding.

FIG. 4 Enlarged view of gypsum board joint with seam tape and spackle to show where to feather the spackle to minimize sanding.

FIG. 5 Enlarged side view of the seam where two gypsum boards come together; shows the seam tape and the joint compound applied over the sea tape and how far taper joint compound extends to a height of zero to avoid sanding.

FIG. 6 Showing a typical wall section with (3) illuminating devices in place to expose exactly where to apply the joint compound.

### DETAILED DESCRIPTION

The present inventive subject matter now will be described more fully hereinafter with reference to the accompanying drawings, in which embodiments of the inventive subject matter are shown. However, this inventive subject matter should not be construed as being limited to the embodiments set forth herein. Rather, these embodiments are provided so that this disclosure will be thorough and complete, and will fully convey the scope of the inventive subject matter to those skilled in the art. Like numbers refer to like elements throughout.

As used herein the term “and/or” includes any and all combinations of one or more of the associated listed items.

The terminology used herein is for the purpose of describing particular embodiments only and is not intended to be limiting of the inventive subject matter. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

When an element such as a layer, region or substrate is referred to herein as being “on”, being mounted “on”, being mounted “to”, or extending “onto” another element, it can be in or on the other element, and/or it can be directly on the other element, and/or it can extend directly onto the other element, and it can be in direct contact or indirect contact with the other element (e.g., intervening elements may also be present). In contrast, when an element is referred to herein as being “directly on” or extending “directly onto” another element, there are no intervening elements present. Also, when an element is referred to herein as being “connected” or “coupled” to another element, it can be directly connected or coupled to the other element, or intervening elements may be present. In contrast, when an element is referred to herein as being “directly connected” or “directly coupled” to another element, there are no intervening elements present. In addition, a statement that a first element is “on” a second element is synonymous with a statement that the second element is “on” the first element.

The expression “in contact with”, as used herein, means that the first structure that is in contact with a second structure is in direct contact with the second structure or is in indirect contact with the second structure. The expression “in indirect contact with” means that the first structure is not in direct contact with the second structure, but that there are a plurality of structures (including the first and second structures), and each of the plurality of structures is in direct contact with at least one other of the plurality of structures (e.g., the first and second structures are in a stack and are separated by one or more intervening layers). The expression “direct contact”, as used in the present specification, means that the first structure which is “in direct contact” with a second structure is touching the second structure and there are no intervening structures between the first and second structures at least at some location.

A statement herein that two components in a device are “electrically connected,” means that there are no components electrically between the components that affect the function or functions provided by the device. For example, two components can be referred to as being electrically connected, even though they may have a small resistor between them which does not materially affect the function or functions provided by the device (indeed, a wire connecting two components can be thought of as a small resistor); likewise, two components can be referred to as being electrically connected, even though they may have an additional electrical component between them which allows the device to perform an additional function, while not materially affecting the function or functions provided by a device which is identical except for not including the additional component; similarly, two components which are directly connected to each other, or which are directly connected to opposite ends of a wire or a trace on a circuit board, are electrically connected. A statement herein that two components in a device are “electrically connected” is distinguishable from a statement that the two components are “directly electrically connected”, which means that there are no components electrically between the two components.

Although the terms “first”, “second”, etc. may be used herein to describe various elements, components, regions, layers, sections and/or parameters, these elements, components, regions, layers, sections and/or parameters should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive subject matter.

Relative terms, such as “below”, “above,” “perpendicular,” “orthogonal,” or “horizontal” may be used herein to describe one element's relationship to another element (or to other elements) as illustrated in the Figures. Such relative terms are intended to encompass different orientations of the device in addition to the orientation depicted in the Figures. For example, if the device in the Figures is turned over, elements described as being below other elements would then be oriented above the other elements. The exemplary term “below” can therefore encompass both an orientation of “below” and “above,” depending on the particular orientation of the figure.

The expression “illumination” (or “illuminated”), as used herein when referring to a light emitter, means that at least some current is being supplied to the light emitter to cause the light emitter to emit at least some electromagnetic radiation (e.g., visible light). The expression “illuminated” encompasses situations where the light emitter emits electromagnetic radiation continuously, or intermittently at a rate such that a human eye would perceive it as emitting electromagnetic radiation continuously or intermittently, or where a plurality of light emitters of the same color or different colors are emitting electromagnetic radiation intermittently and/or alternatingly (with or without overlap in “on” times), e.g., in such a way that a human eye would perceive them as emitting light continuously or intermittently (and, in some cases where different colors are emitted, as separate monochromatic colors or as a mixture of those colors).

The expression “excited”, as used herein when referring to luminescent material, means that at least some electromagnetic radiation (e.g., visible light, UV light or infrared light) is contacting the luminescent material, causing the luminescent material to emit at least some light. The expression “excited” encompasses situations where the luminescent material emits light continuously, or intermittently at a rate such that a human eye would perceive it as emitting light continuously or intermittently, or where a plurality of luminescent materials that emit light of the same color or different colors are emitting light intermittently and/or alternatingly (with or without overlap in “on” times) in such a way that a human eye would perceive them as emitting light continuously or intermittently (and, in some cases where different colors are emitted, as a mixture of those colors).

The expression “lighting device”, as used herein, is not limited, except that it indicates that the device is capable of emitting light. That is, a lighting device can be a device which illuminates an area or volume, e.g., a structure, a swimming pool or spa, a room, a warehouse, an indicator, a road, a parking lot, a vehicle, signage, e.g., road signs, a billboard, a ship, a toy, a mirror, a vessel, an electronic device, a boat, an aircraft, a stadium, a computer, a remote audio device, a remote video device, a cell phone, a tree, a window, an LCD display, a cave, a tunnel, a yard, a lamppost, or a device or array of devices that illuminate an enclosure, or a device that is used for edge or back-lighting (e.g., back light poster, signage, LCD displays), bulb replacements (e.g., for replacing AC incandescent lights, low voltage lights, fluorescent lights, etc.), lights used for outdoor lighting, lights used for security lighting, lights used for exterior residential lighting (wall mounts, post/column mounts), ceiling fixtures/wall sconces, under cabinet lighting, lamps (floor and/or table and/or desk), landscape lighting, track lighting, task lighting, specialty lighting, ceiling fan lighting, archival/art display lighting, high vibration/impact lighting, work lights, etc., mirrors/vanity lighting, or any other light emitting device.

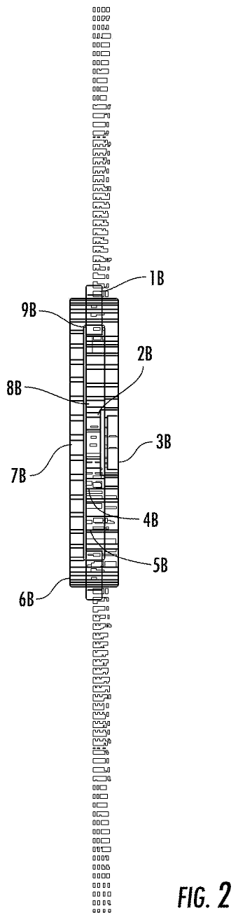

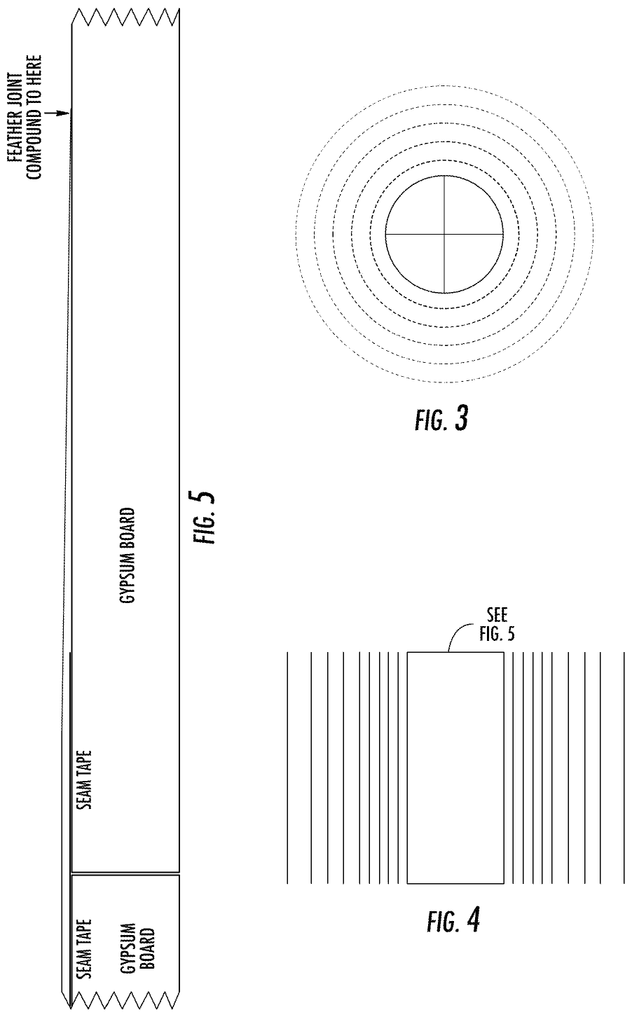

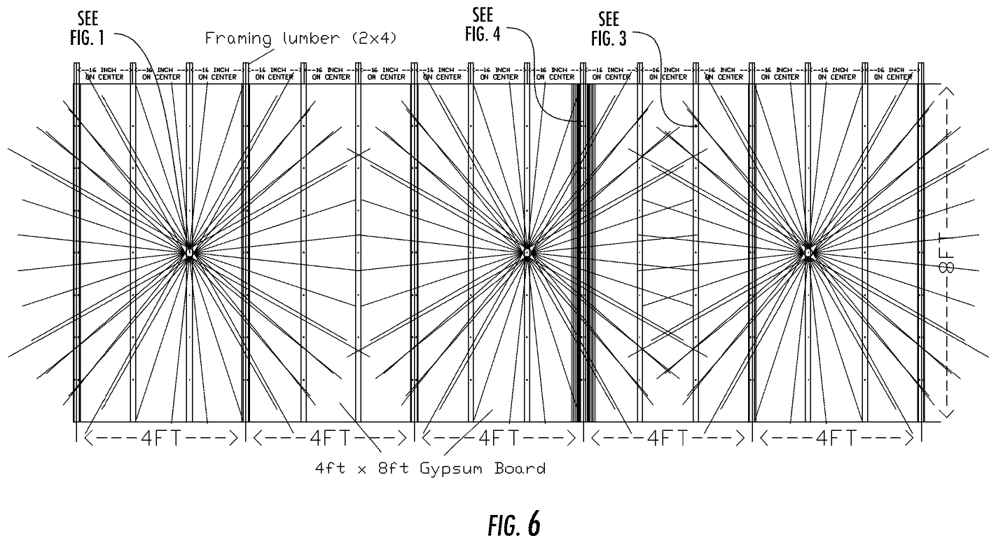

The present inventive subject matter further relates to an illuminated enclosure (the volume of which can be illuminated uniformly or non-uniformly), comprising an enclosed space and at least one lighting device FIG. 2 according to the present inventive subject matter, wherein the lighting device illuminates at least a portion of the enclosed space (uniformly or non-uniformly).

Some embodiments of the present inventive subject matter are directed to a structure comprising a surface and at least one lighting device corresponding to any embodiment of a lighting device according to the present inventive subject matter as described herein, wherein if at least one solid-state light emitter in the lighting device is illuminated, the lighting device would illuminate at least a portion of the surface.

The present inventive subject matter is further directed to an illuminated area, comprising at least one item, e.g., selected from among the group consisting of a structure, a swimming pool or spa, a room, a warehouse, an indicator, a road, a parking lot, a vehicle, signage, e.g., road signs, a billboard, sheetrock, a ship, a toy, a mirror, a vessel, an electronic device, a boat, an aircraft, a stadium, a computer, a remote audio device, a remote video device, a cell phone, a tree, a window, an LCD display, a cave, a tunnel, a yard, a lamppost, etc., having mounted therein or thereon at least one lighting device as described herein.

The expression “axis of emission”, as used herein in connection with light output from one or more light emitters, means an axis of the light emission from the light emitter, a direction of maximum brightness of light emission, or a mean direction of light emission (in other words, in the case of mean direction of light emission, (1) if there is provided a light emitter in which the distribution of the brightness of emitted light is non-Lambertian, e.g., if the distribution of the brightness of emitted light is doughnut-shaped (e.g., the light emitter might itself be toroidal or annular, or a plurality of light emitters might be arranged in a toroidal or annular pattern), e.g., with directions of maximum brightness extending around the doughnut shape in the form of a circle extending about a polar axis, e.g., at about 120 vertical degrees (and extending around the entire 360 lateral degrees, i.e., to define a circle) in a Type C coordinate system, i.e., in which the polar axis is vertical, vertical angles range from 0 degrees (nadir) to 180 degrees (zenith) (90 vertical degrees being equatorial), and lateral angles range from 0 degrees to 360 degrees, the axis of emission might coincide with the vertical axis (e.g., because the mean direction of the maxima lies on the vertical axis), even though the maximum directions of brightness do not themselves lie on the vertical axis, or (2) if the maximum brightness is in a first direction, but a brightness in a second direction ten (or fifty) degrees to one side of the first direction is larger than a brightness in a third direction ten (or fifty) degrees to an opposite side of the first direction, the mean direction of light emission would be moved somewhat toward the second direction as a result of the brightnesses in the second direction and the third direction).

The expression “substantially parallel”, as used herein, means that two lines do not diverge from each other by more than 5 degrees;

Unless otherwise defined, all terms (including technical and scientific terms) used herein have the same meaning as commonly understood by one of ordinary skill in the art to which this inventive subject matter belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein. It will also be appreciated by those of skill in the art that references to a structure or feature that is disposed “adjacent” another feature may have portions that overlap or underlie the adjacent feature.

As noted above, in some aspects, the present inventive subject matter is directed to a lighting device that comprises a trim element and at least a first solid-state light emitter.

A trim element (or regions or portions thereof) in the lighting devices according to the present inventive subject matter can generally be of any suitable size and shape. As detailed herein, different aspects of the present inventive subject matter specify that different characteristics that relate to size and shape for the trim element (or regions or portions thereof) be satisfied.

For example, in some embodiments in accordance with the present inventive subject matter, including some embodiments that include or do not include any of the features described herein, the trim element comprises at least a first region, a second region, and a third region. The trim element is configured to be positioned with at least a first part of the first region in a first space, the second region outside the first space creating a second space, and a third region outside the second space and at least the first solid-state light emitter is at the outmost part of the third region (or outermost region). In some of such embodiments, the first space is defined by a junction box or a can or main body or enclosure, and the first space extends from an opening in a first surface (e.g., as is the case with a conventional recessed light, where a can is installed, e.g., in a ceiling, and defines a space (typically cylindrical or frustoconical) that extends up from an opening which is substantially in the same plane as the ceiling.

In some embodiments in accordance with the present inventive subject matter, including some embodiments that include or do not include any of the features described herein, the trim element comprises at least a first region, a second region, and a third region. The first region is concave.

In some embodiments in accordance with the present inventive subject matter, including some embodiments that include or do not include any of the features described herein, the trim element comprises at least a first region and a second region, the first part of the first region is configured to fit within a junction box space defined by regions of a junction box that comprises a back wall and one or more side walls housing the power supply and magnet (1) spaced from a first plane defined by points on the one or more side walls that are farthest from the back wall and (2) between the first plane and the back wall.

In some embodiments in accordance with the present inventive subject matter, including some embodiments that include or do not include any of the features described herein, the trim element comprises at least a first region and a second region, and the first part of the first region is configured to fit within a junction box.

In some embodiments in accordance with the present inventive subject matter, including some embodiments that include or do not include any of the features described herein, the trim element comprises at least a first region and a second region, and the second region extends from the first region and the plurality of additional regions so forth in this pattern.

In some embodiments in accordance with the present inventive subject matter, including some embodiments that include or do not include any of the features described herein, the trim element comprises at least a first region and a second region, the trim element is configured to be positioned with at least a first part of the first region in a first space, and the first space is defined by regions of a junction box.

In some embodiments in accordance with the present inventive subject matter, including some embodiments that include or do not include any of the features described herein, the trim element comprises at least a first region and a second region, the trim element is configured to be positioned with at least a first part of the first region in a first space and the second region outside the first space, the second region comprises at least a first flange region, and the trim element is configured to be positioned with (1) at least the first part of the first region in a junction box space defined by regions of a junction box mounted in a construction surface and (2) the first flange region in contact with the construction surface. In some of such embodiments: (1) at least a first portion of the first flange region is spaced farther from an axis of emission of the first solid-state light emitter than any portion of the first part of the first region, or (2) the first flange region is annular, and every point on the first flange region is spaced from an axis of emission of the first solid-state light emitter a distance at least as large as the largest distance that any portion of the first part of the first region is spaced from the axis of emission of the first solid-state light emitter.

In some embodiments in accordance with the present inventive subject matter, including some embodiments that include or do not include any of the features described herein, the trim element comprises at least a first region and a second region, the trim element is configured to be positioned with at least a first part of the first region in a first space and the second region outside the first space, the second region comprises at least a first flange region that comprises at least a first planar surface, and the trim element is configured to be positioned with (1) at least the first part of the first region in a junction box space defined by regions of a junction box mounted in a construction surface, (2) the first planar surface of the first flange region in contact with the construction surface, (3) at least a majority of the junction box to a first side of a plane defined by the first planar surface, and (4) the first solid-state light emitter spaced from the plane defined by the first planar surface and to the first side of the plane defined by the first planar surface.

Any suitable solid-state light emitter (or solid-state light emitters) can be employed in the lighting devices according to the present inventive subject matter. Persons of skill in the art are familiar with, and have ready access to, a wide variety of solid-state light emitters. Representative examples of solid-state light emitters include light emitting diodes 1A (inorganic or organic, including polymer light emitting diodes (PLEDs)) and a wide variety of luminescent materials as well as combinations (e.g., one or more light emitting diodes and/or one or more luminescent materials).

The solid-state light emitter(s) in any lighting device according to the present inventive subject matter can be of any suitable size (or sizes), e.g., and any quantity (or respective quantities) of solid-state light emitters of one or more sizes can be employed. In some instances, for example, a greater quantity of smaller solid-state light emitters can be substituted for a smaller quantity of larger solid-state light emitters, or vice-versa.

Light emitting diodes are semiconductor devices that convert electrical current into light. A wide variety of light emitting diodes are used in increasingly diverse fields for an ever-expanding range of purposes. More specifically, light emitting diodes are semiconducting devices that emit light (ultraviolet, visible, or infrared) when a potential difference is applied across a p-n junction structure. There are a number of well-known ways to make light emitting diodes and many associated structures, and the present inventive subject matter can employ any such devices.

A light emitting diode 1A produces light by exciting electrons across the band gap between a conduction band and a valence band of a semiconductor active (light-emitting) layer. The electron transition generates light at a wavelength that depends on the band gap. Thus, the color of the light (wavelength) and/or the type of electromagnetic radiation (e.g., infrared light, visible light, ultraviolet light, near ultraviolet light, etc., and any combinations thereof) emitted by a light emitting diode 1A depends on the semiconductor materials of the active layers of the light emitting diode.

The expression “light emitting diode” is used herein to refer to the basic semiconductor diode structure (i.e., the chip). The commonly recognized and commercially available “LED” that is sold (for example) in electronics stores typically represents a “packaged” device made up of a number of parts.

An embodiment of the LED 1A of the lighting device in the present invention can be defined as an optic of polycarbonate or similar material with internal prisms to project light with an angle of emission of 140-degrees wide parallel to the gypsum board surface FIG. 6 by 5-degrees, with a high “fan type” distribution. The optic of the LED 1A exterior portion to be smooth, easy to clean and glare free when energized.

A luminescent material is a material that emits a responsive radiation (e.g., visible light) when excited by a source of exciting radiation. In many instances, the responsive radiation has a wavelength (or hue) that is different from the wavelength (or hue) of the exciting radiation.

Luminescent materials can be categorized as being down-converting, i.e., a material that converts photons to a lower energy level (longer wavelength) or up-converting, i.e., a material that converts photons to a higher energy level (shorter wavelength).

Persons of skill in the art are familiar with, and have ready access to, a variety of luminescent materials that emit light having a desired peak emission wavelength and/or dominant emission wavelength, or a desired hue, and any of such luminescent materials, or any combinations of such luminescent materials, can be employed, if desired. One type of luminescent material are phosphors, which are readily available and well-known to persons of skill in the art. Other examples of luminescent materials include scintillators, day glow tapes and inks that glow in the visible spectrum upon illumination with ultraviolet light.

The one or more luminescent materials can be provided in any suitable form. For example, the luminescent element can be embedded in a resin(i.e., a polymeric matrix), such as a silicone material, an epoxy material, a glass material or a metal oxide material, and/or can be applied to one or more surfaces of a resin, to provide a luminophore.

The solid-state light emitter (or solid-state light emitters) can be arranged in any suitable way. Persons of skill in the art will readily identify a large number of different possible arrangements, any of which (or any combination of which) can be employed in the lighting devices according to the present inventive subject matter.

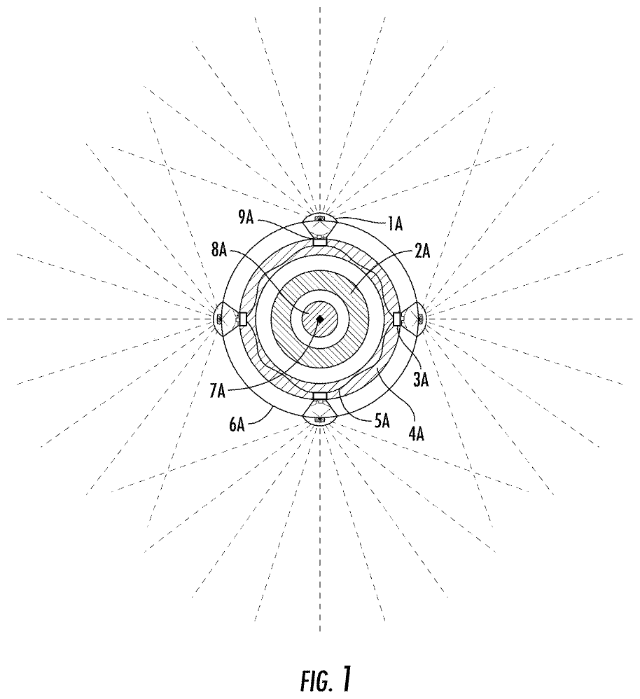

As noted above, in some embodiments in accordance with the present inventive subject matter, including some embodiments that include or do not include any of the features described herein, there is provided a lighting device that comprises at least first, second, third and fourth solid-state light emitters FIG. 1, in which the lighting device is configured to be held relative to a space extending from an opening in a first surface, and in which a distance between the first solid-state light emitter and the second solid-state light emitter is larger than a largest dimension of the opening. In some of such embodiments, the lighting device is configured to be mounted with a first portion of the lighting device in the space, and with at least four of the solid-state light emitters not in the space and spaced from each other by a distance greater than the maximum dimension of the opening (e.g., a first portion of the lighting device is cylindrical with a first diameter, and a second portion of the lighting device, which includes at least four solid-state light emitters, is cylindrical or disc-shaped and is of a second diameter which is greater than the first diameter). For example, a lighting device that has a 6-inch diameter room-side appearance (e.g., light is emitted from solid-state light emitters that are spaced relatively evenly across a region that is nearly 2 and ½ inches in diameter) can be mounted in a space (e.g., defined by a junction box or a can) extending from an opening that is only 1 and ½ inches in diameter (or 1 and ½ inches by 1 and ½ inches square). In some of such embodiments, at least part of a power supply 2A and magnet 8A (or one or more components of a power supply) is in the first portion of the lighting device.

As noted above, in some embodiments in accordance with the present inventive subject matter, including some embodiments that include or do not include any of the features described herein, there is provided a lighting device that comprises a first power supply and at least first, second, third and fourth solid-state light emitters, in which the lighting device is configured to be held relative to a space extending from an opening in a first surface, and in which a distance between the first solid-state light emitter and the second solid-state light emitter directly opposite is larger than a largest dimension of the power supply. In some of such embodiments, the lighting device is configured to be mounted with at least part of a power supply 2A (or one or more components of the power supply) in the space, and two or more solid-state light emitters not in the space.

The solid-state light emitter (or the solid-state light emitters) can be positioned in any suitable way. In some embodiments, for example, the solid-state light emitter (or the solid-state light emitters), or some of two or more solid-state light emitters, can be on one or more circuit boards (which can be positioned in any suitable way, e.g., on the trim element (e.g., on a back region of the trim element). In some embodiments, the solid-state light emitter (or the solid-state light emitters), or some of two or more solid-state light emitters, can be directly on the trim element (e.g., on a back region of the trim element) (in such embodiments, suitable structure for supplying electricity to the solid-state light emitter(s) can be provided, e.g., one or more contacts, one or more terminals and/or one or more conductive traces can be provided).

In some lighting devices in which the solid-state light emitter or one or more of the solid-state light emitters is/are mounted directly on the trim element, one or more thermal element can be provided that is on the trim element in a location where it can serve a specific solid-state light emitter or group of solid-state light emitters. A representative example of a suitable thermal element is a projection that extends from the side of the trim element that is opposite the side on which the solid-state light emitter(s) is/are mounted. A thermal element can be made of any suitable material, and can be of any suitable shape. Use of materials having higher heat conductivity in making the thermal element(s) generally provides greater heat transfer, and use of thermal element(s) of larger surface area and/or cross-sectional area generally provides greater heat transfer. Representative examples of materials that can be used to make the thermal element(s), if provided, include metals, diamond, DLC, etc.

As noted above, in some aspects, the present inventive subject matter is directed to a method using a lighting device that is configured so that a portion of the lighting device can be positioned in a space extending from an opening in a first surface. The space extending from an opening in a first surface can be defined by any suitable structure, a wide variety of which are well-known to persons skilled in the art. For example, the space extending from an opening in a first surface can be defined by a junction box or a can.

As noted above, in some aspects, the present inventive subject matter is directed to a method comprising a lighting device that comprises a junction box FIG. 2, a trim element FIG. 1, a magnet 8A, and at least four solid-state light emitters 1A. In some embodiments in accordance with the present inventive subject matter, including some embodiments that include or do not include any of the features described herein, regions of the junction box define a junction box space, regions of the trim element define a trim element space, at least a first portion of the trim element space is within the junction box space, and at least the first solid-state light emitter is within the first portion of the trim element space. The descriptions of the options and structures for the trim element and the one or more solid-state light emitters set forth above apply to the trim element and the one or more solid-state light emitters in these aspects of the present inventive subject matter.

As noted above, some embodiments of lighting devices according to the present inventive subject matter can comprise a junction box, and/or one or more structures (or one or more parts or portions of structures) can be configured so as to fit within (or to be able to be positioned within) a junction box space defined by regions of a junction box.

Persons of skill in the art are familiar with a wide variety of junction boxes (and dimensions thereof), and any of such junction boxes can be employed in lighting devices in accordance with the present inventive subject matter, and/or any of the dimensions of any of such junction boxes can be applicable in lighting devices in accordance with the present inventive subject matter.

In some embodiments according to the present inventive subject matter that include a junction box, or in which one or more structures (or one or more parts or portions of structures) can be configured so as to fit within (or to be able to be positioned within) a junction box, the junction box, or the junction box with respect to which the configuration of the structures (or one or more parts or portions of structures) of the lighting device is specified has one or more of the following characteristics:

The junction box comprises a back wall and one or more side walls, the first solid-state light emitter is spaced from a first plane defined by points on the one or more side walls that are farthest from the back wall, and the first solid-state light emitter is between the first plane and the back wall;

The junction box is mounted in a construction surface, the trim element comprises at least a first flange region, and the first flange region is in contact with the construction surface;

The junction box is mounted in a construction surface, the trim element comprises at least a first flange region, the first flange region is in contact with the construction surface, the first flange region comprises at least a first planar surface, the first planar surface is in contact with the construction surface, at least a majority of the junction box is to a first side of a plane defined by the first planar surface, the first solid-state light emitter is spaced from the plane defined by the first planar surface, and the first solid-state light emitter is to the first side of the plane defined by the first planar surface.

Regions of the junction box define a junction box space, and the lighting device further comprises a power supply within the junction box space; and the trim element comprises at least a first region and a second region, the lighting device further comprises a power supply, the trim element and the power supply are configured to be positioned with at least a first part of the first region and the power supply in a space defined by regions of a junction box.

Junction boxes having a generally octagonal back wall and eight side walls extending from the eight respective edges of the octagonal back wall and in directions substantially perpendicular to a plane defined by the back wall, defining a junction box space that has a depth of between about 1¼ inches and about 2⅛ inches (e.g., about 1¼ inches or about 2⅛ inches), a width of about 4 inches and length of about 4 inches, in which planes parallel to the back wall that pass through the junction box space intersect with the junction box space in substantially octagonal regions that are each about 4 inches by about 4 inches with equivalent portions of each of the four corners cut off.

Junction boxes having a generally circular back wall and an annular side walls extending from the circular back wall and in directions substantially perpendicular to a plane defined by the back wall, defining a substantially cylindrical junction box space that with a depth and a diameter (i.e., planes parallel to the back wall that pass through the junction box space intersect with the junction box space in substantially circular regions).

In embodiments according to the present inventive subject matter that include a junction box, the junction box can comprise any suitable material or materials. Persons of skill in the art are familiar with a variety of materials that junction boxes can comprise. Representative examples of materials that junction boxes can comprise include metals and plastics.

In some embodiments according to the present inventive subject matter, there can be provided a lighting device that has any suitable structure(s) or component(s) for assisting in holding the lighting device relative to a space, e.g., a space defined by a junction box or a can. For example, a trim element can have one or more holes through which the magnet or battery can be inserted for engagement with a fastener (e.g. a screw head) in a gypsum board (in such embodiments, the holes in the trim element can be arranged to correspond to fasteners in the sheetrock). Alternatively or additionally, a trim element can comprise one or more mechanical structures that can engage a junction box (e.g., a trim element can have one or more biased flanges (e.g., outwardly biased), e.g., that are spring-loaded and/or that have structural memory, and that can for example be retracted (or otherwise be pushed inward) while inserting the trim element into a junction box, and then the structure(s) can be released so that it/they is/are pushed outward (after the trim element is inserted into the junction box), and the structure(s) can hold (or assist in holding) the trim element in place relative to the junction box (e.g., by exerting force against structure that is part of the junction box or connected to the junction box, by physically engaging structure that is part of the junction box or connected to the junction box, and/or by resting on structure that is part of the junction box or connected to the junction box, e.g., gravitational force holds the structure on the trim element on structure that is part of the junction box or connected to the junction box).

As noted above, in some embodiments in accordance with the present inventive subject matter, including some embodiments that include or do not include any of the features described herein, there are provided lighting devices that comprise one or a plurality of magnets for mounting. Such mounting magnets (and structure for attaching them to a lighting device, structure for restricting or inhibiting movement of mounting magnets, or structure for causing or allowing movement of mounting magnets) can comprise any structure. Such mounting magnets can retain (or assist in retaining) lighting devices in a space extending from an opening in a first surface, e.g., in a space defined by a junction box or a can.

In some aspects of the present inventive subject matter, there is provided a lighting device that comprises a housing and a removable bracket, the removable bracket comprising a body member and at least one mounting magnet, the at least one mounting magnet configured to hold the lighting device relative to a space extending from an opening in a first surface. In some of such embodiments, the removable bracket can be any bracket as described herein. In some of such embodiments, the housing (if included) can generally be of any suitable shape and size, and can be made out of any suitable material or materials. Representative examples of materials that can be used in making a housing include, among a wide variety of other materials, extruded aluminum, powder metallurgy formed aluminum, die cast aluminum, liquid crystal polymer, polyphenylene sulfide (PPS), thermoset bulk molded compound or other composite material. In some embodiments in accordance with the present inventive subject matter, which can include or not include, as suitable, any of the other features described herein, a housing (if included) can comprise a material that can be molded and/or shaped, and/or it can comprise a material that is an effective heat sink (i.e., which has high thermal conductivity and/or high heat capacity).

In some embodiments of lighting devices according to the present inventive subject matter, there can be provided one or more structures that allow a lighting device to be accommodated injunction boxes of different sizes and/or shapes (e.g., mounting magnets can flex a distance, whereby they can hold a lighting device relative to spaces of different sizes and/or shapes, and/or a snap-out flange can be provided that can engage structures (e.g., junction boxes or cans) that define spaces of different sizes and/or shapes, and/or different sized and/or shaped flanges can be provided that can be selected that can hold a lighting device in place relative to structures (e.g., junction boxes or cans) that define spaces of respective different sizes and/or shapes.

As noted above, some embodiments according to the present inventive subject matter comprise a power supply 2A that is within a space defined by regions of a junction box, and/or comprise a trim element and a power supply 2A which are configured to be positioned with at least the first part of a first region of the trim element and the power supply 2A in a space defined by regions of a junction box.

In some embodiments in accordance with the present inventive subject matter that comprise a power supply, a power supply 2A can comprise any electronic components that are suitable for a lighting device, for example, any of (1) one or more electrical components employed in using DC electrical power, (2) one or more electronic components employed in driving one or more light emitter, e.g., running one or more light emitter intermittently and/or adjusting the current supplied to one or more light emitters in response to a user command, a detected change in intensity or color of light output, a detected change in an ambient characteristic such as temperature or background light, etc., and/or a signal contained in the input power, etc., (3) one or more circuit boards (e.g., a metal core circuit board) for supporting and/or providing current to any electrical components, and/or (4) one or more wires connecting any components, e.g. electronic components such as linear current regulated supplies, pulse width modulated current and/or voltage regulated supplies, bridge rectifiers, transformers, power factor controllers etc.

In some embodiments in accordance with the present inventive subject matter that comprise a power supply (e.g., in some embodiments that comprise a power supply that is within a space defined by regions of a junction box, or that is configured to be able to fit within such a space), the overall size of the power supply can be reduced or minimized by using a high voltage electricity supply (e.g., a boost configuration), by using a high frequency operation (e.g., 1 GHz or higher), and/or any other suitable way.

In some embodiments in accordance with the present inventive subject matter that comprise a power supply (e.g., in some embodiments that comprise a power supply that is within a space defined by regions of a junction box, or that is configured to be able to fit within such a space), the power supply can be divided into two or more sections, whereby one or more sections of the power supply can be within the space (or can be able to fit within such a space) and one or more sections of the power supply can be outside the space (or can be able to be outside the space), or two or more section of the power supply can be within different regions of the space (or can be able to fit within different regions of such a space).

Components in lighting devices according to the present inventive subject matter can be electrically connected to one another, or to supplied energy 5A (e.g., line voltage), in any suitable way, a wide variety of which are well-known to those of skill in the art and a wide variety of which would be readily apparent to those of skill in the art. In some embodiments in accordance with the present inventive subject matter (e.g., embodiments that comprise a power supply that is within a space defined by regions of a junction box, or that is configured to be able to fit within such a space), electrical connection to one or more components of the lighting device can be accomplished using terminals (e.g., on an exterior of a power supply housing, if included), or with poke-home connections (similar to wiring methods used for typical electrical outlets), or any other type of connection that assists in saving space (e.g., within a junction box).

As noted above, in some aspects, the present inventive subject matter is directed to a method comprising a lighting device that comprises a first power supply 2A, at least a first optic lens 1A, and at least a first solid-state light emitter 9A, an LED Driver with a heat sink 3A, a wireway 4A, low voltage wire 5A, a main body or enclosure 6A, a power supply switch 7A, and a magnet 8A. The lighting device configured to be held relative to a space extending from an opening in a first surface, at least one dimension of the first lens is larger than a largest dimension of the power supply. In some of such embodiments, the lighting device is configured to be mounted with at least part of a power supply (or one or more components of the power supply) and mounting magnet in the space, and at least a portion of at least one lens not in the space.

In embodiments in accordance with the present inventive subject matter that include a diffusion element (or plural diffusion elements), the diffusion element of the lighting device (or diffusion elements) can be positioned in any suitable location and orientation to illuminate depressions, aberrations or anomalies of the gypsum board.

For example, in embodiments that comprise a first flange region, a diffuser can be provided which is in contact with at least the first flange region.

In embodiments in which a trim element is provided that comprises at least a first region and a second region, the trim element configured to be positioned with at least a first part of the first region in a first space and the second region outside the first space, a diffuser can be provided which is within the first space.

A diffusion element, if included, can be provided, for example, by a random array of light diffusing features, such as a randomly sized and/or spaced microlens array.

In some embodiments in accordance with the present inventive subject matter, which can include or not include, as suitable, any of the other features described herein (e.g., the possible inclusion of one or more diffusers), light exiting from the lighting device can have good uniformity of color hue. The expression “good uniformity of color hue”, as used herein, can indicate that when light emitters are emitting light, each of at least 50 (and in some instances 100, 200, 300, 500 or 1,000) non-overlapping conceptual square regions of approximately equal size (not physically defined, but instead defined by imaginary lines) of a region through which light exits the lighting device have a color hue that is within 0.01 unit of a first color point on a 1976 CIE Chromaticity Diagram (each of the non-overlapping square regions comprising a corresponding percentage of a total surface area of the exit region, e.g., each of 50 square regions comprising 1/50 of the total surface area, or each of 100 square regions comprising 1/100 of the total surface area, or each of 500 square regions comprising 1/500 of the total surface area, etc.). In some situations, “good uniformity of color hue” (and/or “good uniformity of emitted light color”) can be assessed based on whether or not the color hue uniformity requirements of the L Prize are met. In some situations, “good uniformity of color hue” (and/or “good uniformity of emitted light color”) can mean that there is less than 500 K CCT variation over the surface of a region through which light exits the lighting device.

In some embodiments in accordance with the present inventive subject matter, which can include or not include, as suitable, any of the other features described herein, light exiting from the lighting device can have good uniformity of brightness. The expression “good uniformity of brightness”, as used herein, can indicate (1) that when the light exiting from the lighting device is directed toward a first surface FIG. 6 (e.g., in some cases, a relatively flat surface, e.g., in some cases, that is generally perpendicular to a first line connecting the lighting device (or a center of an emission surface of the lighting device) and the point of maximum emission), there are no regions (patches) on the first surface where the brightness of light emitted from the lighting device is significantly different from neighboring regions (patches), or there or no significant rings of light (where the brightness of light emitted from the lighting device significantly differs from the brightness of light emitted from the lighting device in neighboring rings, e.g., if a first region on the first surface is defined as points where a line connecting the point with a center of an emission surface of the lighting device defines an angle of between 0 and 2.5 degrees relative to the first line, a second region on the first surface is defined as points where a line connecting the point with a center of an emission surface of the lighting device defines an angle of between 2.5 and 5 degrees relative to the first line, a third region on the first surface is defined as points where a line connecting the point with a center of an emission surface of the lighting device defines an angle of between 5 and 7.5 degrees relative to the first line, a fourth region on the first surface is defined as points where a line connecting the point with a center of an emission surface of the lighting device defines an angle of between 7.5 and 10 degrees relative to the first line, an average brightness of light emitted from the lighting device in the first region is great than that in the second region, which is in turn greater than that in the third region, which is in turn greater than that in the fourth region, or (2) that any suitable light distribution defined by the Illumination Engineering Society is satisfied, or (3) that when one or more light emitters emit light, each of at least 1000 non-overlapping conceptual square regions (again, not physically defined, but instead defined by imaginary lines) of a region through which light exits the lighting device have a brightness that is within 5 percent of a first brightness (each of the at least 1000 non-overlapping square regions comprising 0.08 percent of a total surface area of the region through which light exits the lighting device).

As noted above, in some embodiments in accordance with the present inventive subject matter, structure (e.g., a can or a junction box) that defines a space (in which at least a portion of a lighting device according to the present inventive subject matter can fit) can be mounted in a construction surface FIG. 6 (e.g., a ceiling, a wall or a floor, for example, made of gypsum board or wood). In such embodiments, a lighting device according to the present inventive subject matter can be magnetically-mounted to the construction surface FIG. 6, or can be spaced from the construction surface in any suitable way. In some embodiments in accordance with the present inventive subject matter, one or more accessory to provide directional lighting and/or shielding, etc. For example, in some embodiments, a 4 ft by 8 ft gypsum board structure FIG. 6 (with an anomalies and/or depressions on its surface) can be provided to have the method of this invention use the ceiling-mounted lighting device, with the structure mounted so that it has a first periphery in a plane substantially perpendicular to the ceiling and defining a point that extends upward in the middle of a 4 ft by 8 ft gypsum board to direct emitted light across the gypsum board surface, to act as a light for illuminating depressions, anomalies and other defects from above, a light for illuminating a wall, etc. (in other embodiments, such a ceiling could be flipped so that it directs light downward or horizontally, or an accessory for transferring the lighting device (which can be movable, if desired) can be in any other suitable shape and orientation.

In some embodiments, the lighting devices are configured to provide lumen output of any specific quantity, e.g., at least 500 lumens, and in some embodiments, at least 600 lumens, at least 700 lumens, at least 800 lumens, at least 900 lumens, at least 1,000 lumens, at least 1,500 lumens, at least 2,000 lumens, at least 2,500 lumens, at least 3,000 lumens, at least 4,000 lumens, or more.

In some aspects of the present inventive subject matter, which can include or not include any of the features described elsewhere herein, there are provided lighting devices that provide at least 75% of the lumen output of the lamp for which the lighting device is a replacement, and in some cases, at least 85%, 90%, 95%, 100%, 105%, 110%, 115%, 120% or 125% of the lumen output of the lamp for which the lighting device is a replacement.

Energy can be supplied to the lighting device from any source or combination of sources, for example, the grid 4A (e.g., line voltage 5A), one or a plurality battery 2B, one or more photovoltaic energy collection devices (i.e., a device that includes one or more photovoltaic cells that convert energy from the sun into electrical energy). It is also possible for the lighting device to be powered in the form of heat transfer from one body that excites a energy transfer unit 3A within the device to supply energy and power to excite and illuminate the LED diodes.

Embodiments in accordance with the present inventive subject matter are described herein in detail in order to provide exact features of representative embodiments that are within the overall scope of the present inventive subject matter. The present inventive subject matter should not be understood to be limited to such detail.

Embodiments in accordance with the present inventive subject matter are also described with reference to cross-sectional (and/or plan view) illustrations that are schematic illustrations of idealized embodiments of the present inventive subject matter. As such, variations from the shapes of the illustrations as a result, for example, of manufacturing techniques and/or tolerances, are to be expected. Thus, embodiments of the present inventive subject matter should not be construed as being limited to the particular shapes of regions illustrated herein but are to include deviations in shapes that result, for example, from manufacturing. For example, a molded region illustrated or described as a rectangle will, typically, have rounded or curved features. Thus, the regions illustrated in the figures are schematic in nature and their shapes are not intended to illustrate the precise shape of a region of a device and are not intended to limit the scope of the present inventive subject matter.

The lighting device illustrated herein is illustrated with reference to cross-sectional drawings. These cross-sections may be rotated around a central axis to provide lighting devices that are circular in nature. Alternatively, the cross-sections may be replicated to form sides of a polygon, such as a square, rectangle, pentagon, hexagon or the like, to provide a lighting device. Thus, in some embodiments, objects in a center of the cross-section may be surrounded, either completely or partially, by objects at the edges of the cross-section. This portable device skims the surface with light to quickly and accurately identify surface imperfections that can be sanded, scraped, filled, or otherwise corrected prior to painting. Surfaces can be horizontal, vertical, angled or curved. The shape of the device can be round, square, triangular, rectangle or shaped to achieve the best results. The housing material can be plastic, aluminum, titanium or any synthetic or alloy material to meet performance requirements. The device utilizes a heavy-duty magnet to affix to the screws or nail already in the wall that holds up the gypsum board, or by other means as required for the application. The device can also range in size as required for the application. Shape can be rigid or flexible, as required for the application. Works in low light levels and high ambient light levels. Housing color to be bright colors for ease in locating the product. The housing to be color coded to identify a specific purpose for that device. For example, the output or distribution of the light. The product housing to be IP68/submerged rated and shock/drop resistant. The housing to be easily cleaned with water and have no edges to hold spackle, paint, and other debris.

The light source to be LED with a Kelvin Temperature can range for 2000K to 6500 K. or RGB as required for the application. The battery shall be long life lithium or rechargeable via a wireless recharger supplied with the system. Devices can be stacked to recharge. Device shall be turned on/off via a momentary push button or remotely via wireless Bluetooth through and APP of a smart phone. The remote on/off feature allows the device to remain in place until the area is complete. Your reference points from the day before are preserved and therefore, rework is kept to a minimal.

Product to also be furnished as a kit. The kit can be supplied with multiple illuminating devices, a charger, marking tape, marking stickers and/or a writing tool like a chalk pencil. The included roll of labels to be in the shape of arrows and other symbols to be put on surfaces to show where additional filling, sanding, scraping, and feathering is required in preparation of paint.

The lighting device further can be used with a plurality of other user devices. User devices may be laptops, smartphones, tablets, or VR tools and the like which connect to data stored on at least one server via network. User devices may have only read access to data stored on server.

The use of the terms “a” and “an” and “the” and “at least one” and similar referents in the context of describing the invention (especially in the context of the following claims) are to be construed to cover both the singular and the plural unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B) unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Below is a prophetic example of an embodiment of how this invention would be used in practice.

Example of an application for this product:

The inventor has a garage with a second-floor space. This area is about 13 ft×26 ft with the walls being 8 ft high. The inventor had the space plastered with sheetrock, seam taped, corner trim and one coat of joint compound applied a few years ago.

A lack of confidence with inventor's spackling skills has put this stage of completing this job on hold. The other issue is the cost to hire a professional was outside the inventor's budget.

Using the method of the disclosed invention would help to move it forward again. With this product, the first step of applying one think coat of joint compound has already been completed. This would have been without the method of this invention being utilized, so the inventor can move to the next step

The next step would be to attach a device with the magnet to a screw head and space them roughly 6 ft apart. For this size space (16) devices, evenly spaced would cover all the walls and ceiling at one time. This would make it so one did not need to move the devices and lose the reference points on the surfaces.

The second layer of joint compound would then be applied to the seams, corner trim and screw holes. Making sure that the edges of the joint compound were tapered to the height zero, matching the height of the drywall.

The devices would be shut off remotely with a remote control or via Bluetooth and an APP on a phone.

The following step would be the next day after the joint compound had dried. The devices would be turned back on and the third coat of joint compound would be applied, following the same tapering procedure as in step two. Once all areas were covered, the devices would then be shut down for the day.

The following day the surfaces could be inspected and marker labels or a chalk pencil applied where additional attention was needed. Once all surfaces pass inspection, the paint can now be applied.

Below is another example of how the disclosed invention would be practiced

This product can be used on a small scale and also expanded to a larger scale. The device could help homeowners who do small to medium home improvements like kitchens, bathrooms or finishing a basement. Figuring a room 10 ft×10 ft would use (10) devices to cover the walls and ceiling. These devices could be purchased in a package of (10) pieces with a remote and charger.

For a home improvement contractor, if they were working on a single-family home total remodel, they may have (10) rooms total. This would require a more substantial system to carry and quickly inventory the devices. This system may be organized in a carrying device similar to the ones shown below that are used for poker chips. The center portion could be used for marking products.

This system would have (100) devices, organizing/carrying system, chargers and Bluetooth enabled devices.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method to minimize or eliminate sanding by illuminating an area by showing contrasting areas of light and dark distinguishing depressions, aberrations or anomalies in the gypsum board and where to fill and taper a plurality of layers of joint compound to finish gypsum boards to a height of zero using a device comprising:
a) A portable device comprising:
a main body;
a plurality of light emitting diodes;
a plurality of ultraviolet LED diodes mounted to the main body so that ultraviolet light from the LED is directed away from the device;
a magnet mounted to the main body; and
a power source linked to the ultraviolet LED to provide power thereto.
b) A framework having a first side;
c) A mounting means secured to a fastener in the framework for securing the portable device to said framework to the structure such that the portable device may be positioned to face the gypsum board;
d) Applying joint compound to an area illuminated by the portable device until the edges of the joint compound are tapered to the height zero, matching the height of the gypsum board;
e) Joint compound is applied on subsequent days on the gypsum board after a previous layer joint compound has dried on surface of the gypsum board;
f) The surface of the gypsum board is inspected with the lighting device before painting.

2. The method according to claim 1 where the main body is mounted with magnets.

3. The method according to claim 1 wherein the LED diode has a color temperature between 3500 K and about 6500 K.

4. The method according to claim 1 wherein the LED diode disperses light with an angle of emission at 140 degrees in a plane perpendicular to the centerline of the lighting device.

5. The method according to claim 4 wherein the LED diode disperses light parallel to the wall.

6. The method according to claim 4 wherein a centerline of said angle the LED diode disperses light has an angle of refraction measuring 70 degrees.

7. The method according to claim 1 wherein the LED diode wherein a color rendering index (CRI) of the collective light emission is greater than about 90, and wherein a CRI of the overall light emission is less than the CRI of the collective light emission.

8. The method according to claim 1 wherein the power source is a battery.

9. The method according to claim 7 wherein the battery is rechargeable.

10. The method according to claim 1 wherein the magnet connects to a fastener in a gypsum board.

11. The method according to claim 7 wherein the fastener comprises a metal.

12. A device to locate depressions, aberrations or anomalies in gypsum board comprising:
a. A main body
b. a plurality of light emitting diodes;
c. a plurality of ultraviolet LED diodes mounted to the main body so that ultraviolet light from the LED is directed away from the device;
d. a magnet mounted to the main body; and
e. a power source linked to the ultraviolet LED to provide power thereto.
f. A framework having a first side;
g. A mounting means secured to the framework for securing the portable device to said framework to the structure such that the portable device may be positioned to face the gypsum board.

13. The use of a device to eliminate sanding in gypsum board comprising:
a main body;
a plurality of light emitting diodes;
a plurality of ultraviolet LED diodes mounted to the main body so that ultraviolet light from the LED is directed away from the device;
a magnet mounted to the main body; and
a power source linked to the ultraviolet LED to provide power thereto.
b) A framework having a first side;
c) A mounting means secured to the framework for securing the portable device to said framework to the structure such that the portable device may be positioned to face the gypsum board.
